(19) United States
(12) Patent Application Publication
(10) Pub. No.: US 2010/0187783 A1
(43) Pub. Date: Jul. 29, 2010

(54) Camera Mounting Apparatus

(76) Inventor: Matthew Edward Rosen, City of Makati (PH)

Correspondence Address: AKERMAN SENTERFITT, P.O. BOX 3188, WEST PALM BEACH, FL, 33402-3188, US

(21) Appl. No.: 12/304,437

(22) PCT Filed: Jun. 15, 2006
(86) PCT No.: PCT/PH2006/000012

§ 371 Date: Apr. 1, 2010

(51) Int. Cl. B62B 3/00; B65G 21/22

(52) U.S. Cl. 280/47.11

(57) ABSTRACT

A camera mounting apparatus adapted to run through a triangular track members comprising a rectangular base, a rotatable plate pivotably mounted on top of said rectangular base, a tillable plate tiltably secured on said rotatable plate and a pair of spaced apart detachable wheel assemblies (13) securedly supporting said rectangular base and adapted to traverse along said track members.

The present invention relates generally to camera dollies but more particularly to a camera mounting apparatus.

In the production of motion pictures, the motion picture camera must often be moved from one position to another. The camera movements may require a change in camera position, camera angle, or camera elevation. The camera movement must be performed smoothly, as even small amounts of vibration of the camera can result in unsatisfactory filming, due to shaky or erratic recorded images. For certain film sequences, the camera must be held in a fixed position. In other film sequences, the camera must be continuously and rapidly moved to follow an action or moving sequence. Similar requirements must often be met when using television cameras.

Camera dollies and pedestals have long been used to support and move motion picture cameras. Typically, a camera dolly has four wheels or pairs of wheels on a chassis having a generally rectangular wheel base. The wheels may be attached to the chassis via articulated legs, or the wheels may be directly pivotably attached to the chassis.

The camera dolly is pushed over the floor by dolly operators. During filming on sand, grass, or other uneven surfaces, the dolly may be placed on rails or tracks to provide an even and smooth rolling surface. The dolly wheels may be adapted for both ground and track operation, or separate ground and track wheels may be supplied as accessories, to be installed, on the dolly as needed. Larger camera dollies may be self-propelled using electric motors and on-board batteries. Camera pedestals provide similar functions and are used primarily in television studios.

The problem with existing camera dollies rolling on tracks, is that when shooting a low target, the pedestal has to be tilted at an angle, whereby the lower the target is, the more stiffer angles is required which may cause the camera or the entire assembly to topple down from the track. Furthermore, the movements of these camera dollies are very limited such that some requirement like projecting from the floor while encircling a target cannot be done.

The primary object of the present of this invention therefore is to provide a camera mounting apparatus that can be easily assembled and disassembled at the site saving a lot time therefore.

Another object is to provide an invention for a camera mounting apparatus having an adjustable tilting plate that can be tilted as far as 90 degrees from the horizontal when shooting a target located below.

Still an object of this invention for a camera mounting apparatus having a pair of telescopic counter balance to counter the weight of the camera when being tilted.

Another object is to provide an invention for a camera mounting apparatus having a turnable wheels to allow the camera from move on a circularly from the target.

These and other objects and advantages will come to view and be understood upon a reading of the detailed description when taken in conjunction with the appended drawings:

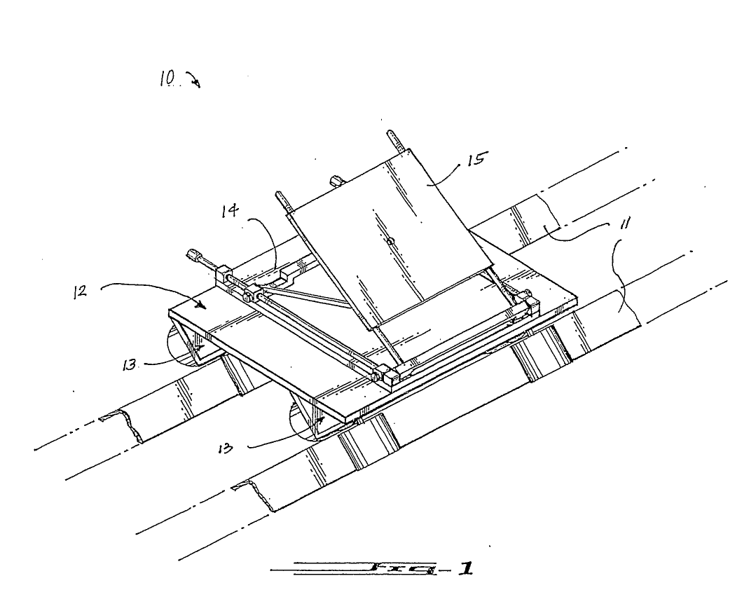

FIG. 1 is a perspective view of the present invention for a camera mounting apparatus on a track;

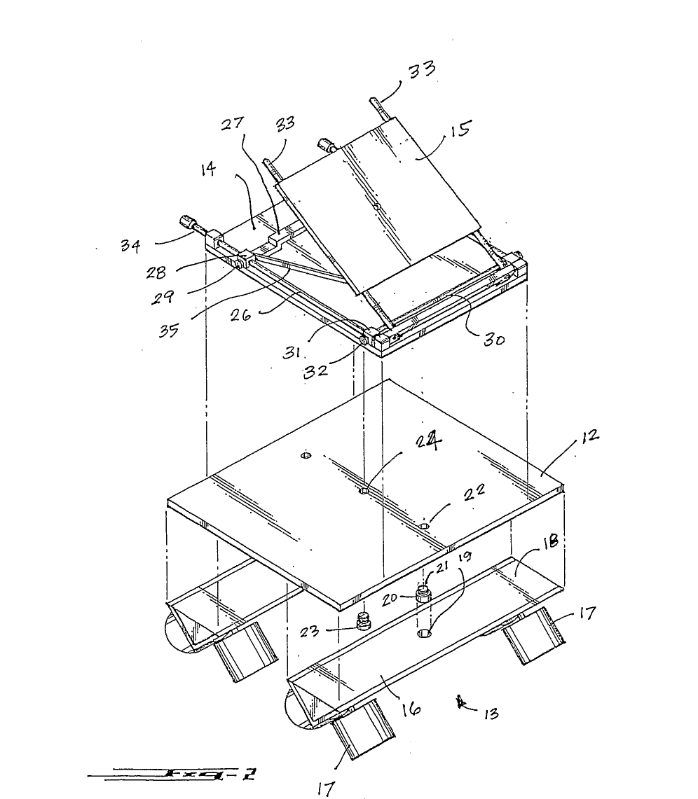

FIG. 2 is an exploded view;

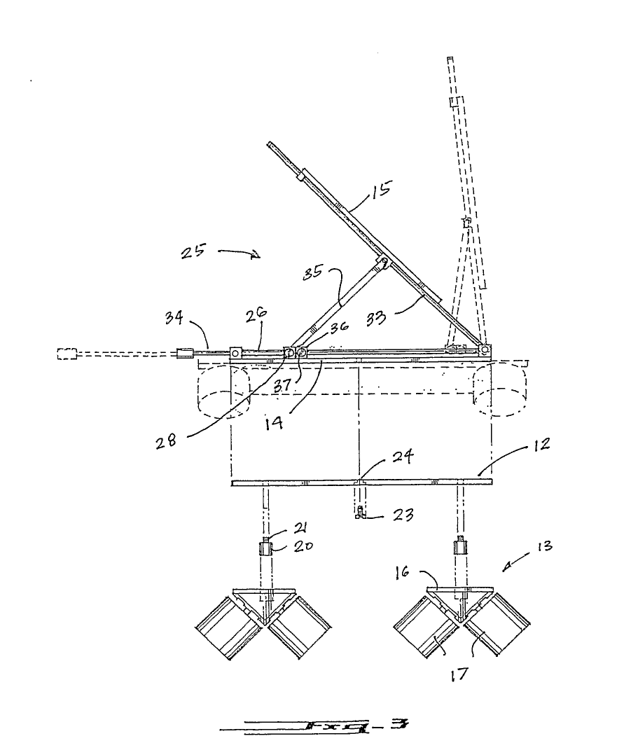

FIG. 3 is a side exploded view;

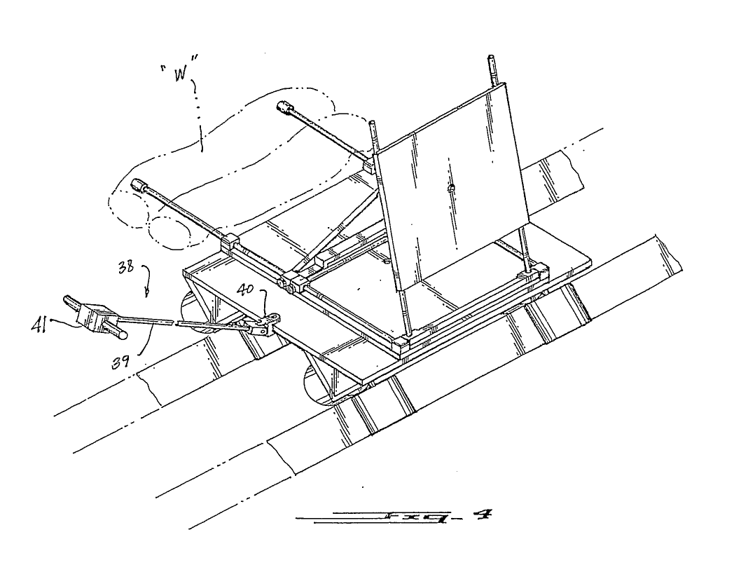

FIG. 4 shows another embodiment of the present invention on a track;

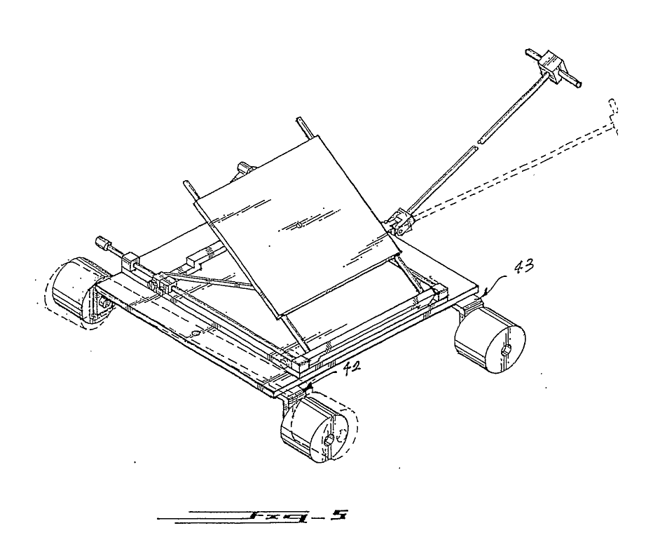

FIG. 5 is a perspective view of FIG. 4 moving along a planar surface;

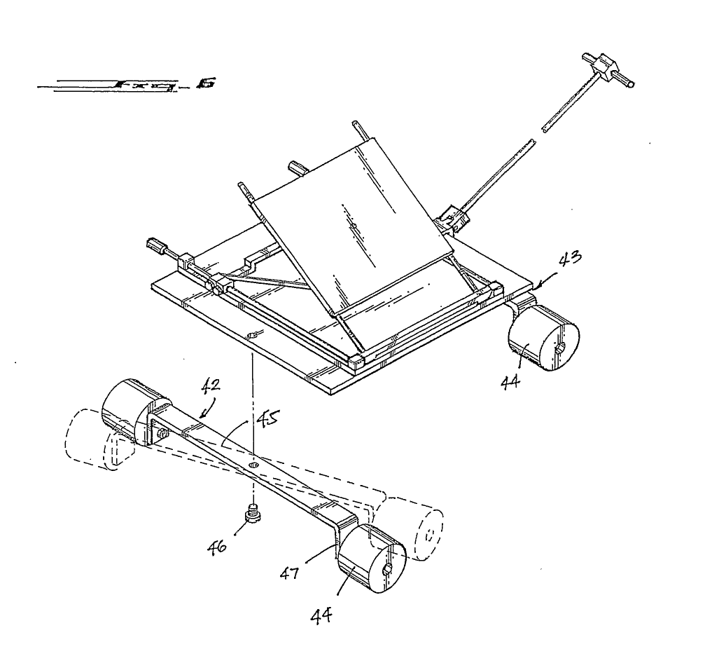

FIG. 6 is a perspective view with detached front wheels;

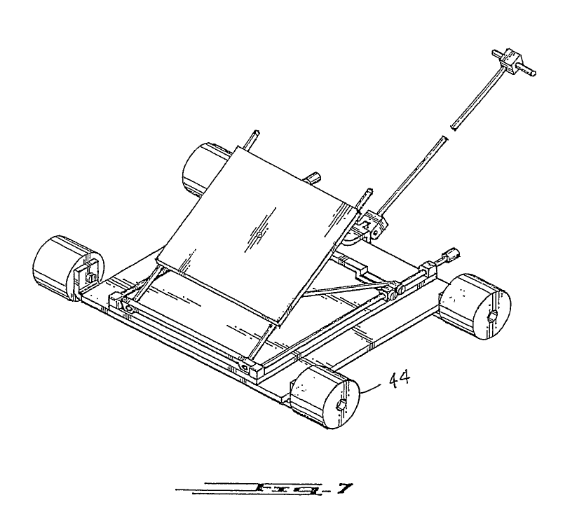

FIG. 7 is a perspective view of the present invention with the wheels in the low mode; and

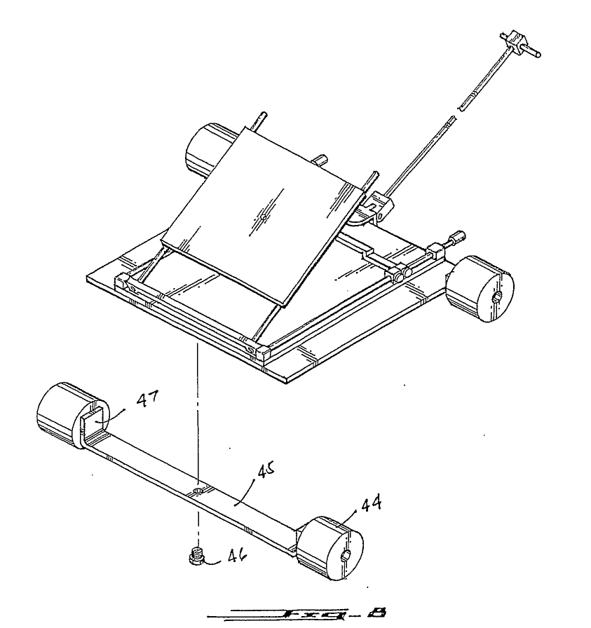

FIG. 8 is a partial exploded view thereof.

Referring now to the several views of the drawing in detail, there is shown a camera mounting apparatus generally designated as reference numeral 10.

Said camera mounting apparatus 10 as shown in FIG. 1 is adapted to be mounted on top of a pair of track members 11 and comprises a rectangular base 12, a pair of spaced apart detachable wheel assemblies 13 securedly supporting said rectangular base 12, a rotatable plate 14 pivotably mounted on top of said rectangular base 12 and a tiltable plate 15 tiltably secured on said rotatable plate 14.

Each of said wheel assemblies 13 is defined by an elongated triangular body 16 that covers the entire length of said rectangular base 12, and two pairs of angular rubber wheels 17 opposedly provided at the lower ends of said triangular body 16. Said pairs of angular rubber wheels 17 are so designed to fit the angular surface of the track members 11. The top portion 18 of said triangular body 16 is provided with a circular depression 19 on to where a cylindrical insert 20 is removably fitted. A protruding means 21 extends upwardly of said insert 20 and is removably secured to a bore 22 provided to the bottom face and near the side ends said rectangular base 12.

Said rotatable plate 14 is pivotably and screwably mounted on top of said rectangular base 12 by a set-screw 23. Said set-screw 23 traverses through a hole 24 on said rectangular base 12 and screwably secured at the bottom face of said rotatable plate 14.

The tiltable plate 15 is secured to said rotatable plate 14 by means of tilting mechanism 25 consisting of a pair of opposed transverse tube 26 fixed on top of said rotatable plate 14, a cross-member 27 slidably connecting said pair of opposed transverse tubes 26 through a pair of opposed clamps 28 respectively provided at ends thereof, a locking screw 29 being provided to each of said clamps 28 for securing thereof to respective transverse tubes 26, a rotatable shaft 30 connecting one of the ends of said transverse tubes 26, whereby the opposing ends of said rotatable shaft 30 are being provided with respective securing clamps 31 screwably secured to the ends of said transverse tubes 26 by screws 32, a pair of opposing arms 33 spacedly projecting perpendicularly from said rotatable shaft 30 on to where said tilting plate 15 is secured, a pair of counter weight rods 34 telescopically slidable within the respective transverses tube 26 to counter balance the weight of the camera (not shown) mounted thereon when said camera is tilted downwardly, a pair of opposing brackets 35 having one ends supporting the middle portion of the said opposing arms 33 and other opposing ends secured respectively to the opposing ends of said cross-member 27, and a locking clamp 36 slidably to each of said transverse tubes 26, said locking clamps 26 is provided with a lock screw 37 to secure said locking clamps 26 thereto and prevent the tilting plate 15 from accidental tilting over due to the weight of the camera (not shown). As shown in the drawings, the counter weight rods 34 can be mounted with additional weights “W” such as sand bags to ensure the weight of the camera would be neutralized.

In FIG. 4 of the drawing, said rectangular base 12 is removably provided with a handle bar 38 for dollying forwardly or backwardly through said track members 11. Said handle bar 38 consists of an elongated bar 39 having a connecting member 40, one end thereof being screwably secured to said rectangular base 12 and the other end being provided with a holder 41 adapted to be used for pushing or pulling said camera mounting apparatus.

FIGS. 5 to 8 shows the camera mounting apparatus 10 being dismounted from the track members 11 and allowed to move along the floor, table or any smooth surfaced plane. In this embodiment, the pair of wheel assemblies 13 are replaced with a pair of spaced apart front and rear axles 42 and 43 with corresponding cylindrical rubber wheels 44. The front and rear axles 42 and 43 are each defined by an elongated flat bar 45 having the central portion screwably secured at the bottom of said rectangular base 12 by a securing bolt 46, the opposing ends of said elongated flat bar 45 are respectively provided with perpendicularly projecting wheel base 47 on to where the cylindrical rubber wheels 44 are rotatably attached. As shown, said front and rear axles 42 and 43 can be alternatively turned to an angle from said securing bolt 46 to allow a turning movement should the camera is required to shoot in a circling motion. This embodiment is used to shoot low targets, such going through under automobiles, chairs or tables. It can also used to shoot a human subject or the like from the floor. FIGS. 7 and 8 show likewise that the front and rear axles 42 and 43 can be turned upside-down to be in a super low mode.

1. A camera mounting apparatus adapted to run through a triangular track members comprising a rectangular base, a rotatable plate pivotably mounted on top of said rectangular base, a tiltable plate tiltably secured on said rotatable plate and a pair of spaced apart detachable wheel assemblies 13 securedly supporting said rectangular base and adapted to traverse along said track members.

2. A camera mounting apparatus according to claim 1 wherein said tiltable plate including a tilting mechanism being defined by a pair of opposed transverse tube fixed on top of said rotatable plate, a cross-member slidably secured to said pair of opposed transverse tubes, through a pair of opposed clamps respectively provided at ends thereof, a rotatable shaft connecting one of the ends of said transverse tubes, a pair of opposing arms spacedly projecting perpendicularly from said rotatable shaft on to where said tilting plate being secured, a pair of counter weight rods telescopically slidable within the respective transverses tube, a pair of opposing brackets having one of the ends supporting the middle portion of the said opposing arms and other ends secured respectively to the opposing ends of said cross-member, and a locking clamp screwably slidable to each of said transverse tubes.

3. A camera mounting apparatus according to claim 1 wherein each of said wheel assembly being defined by an elongated triangular body and two pairs of angular rubber wheels opposedly provided to said triangular body that are mounted to said track members.

4. A camera mounting apparatus according to claim 1 wherein each of said wheel assembly being defined by a detachable turnable elongated flat bar screwably secured at the bottom of said rectangular base, a wheel base perpendicularly projecting from the opposing ends of said elongated flat bar, a cylindrical rubber wheels rotatably attached to each of said wheel base.
